(19) United States
(12) Patent Application Publication
(10) Pub. No.: US 2007/0133988 A1
(43) Pub. Date: Jun. 14, 2007

(54) GPON system and method for bandwidth allocation in GPON system

(76) Inventors: Yu-Gun Kim, Yongin-si (KR); Byeong-Hoon Kim, Suwon-si (KR); Tae-Sung Park, Yongin-si (KR); Jeong-Won Park, Yongin-si (KR); Jai-Young Park, Seoul (KR); Jong-Kook Kim, Seoul (KR); Dong-Keun Kim, Gunpo-si (KR); Su-Hyung Kim, Seoul (KR); Jae-Young Lee, Seoul (KR); Jae-Hyun Kim, Seoul (KR); Hoon-Jae Yeon, Seoul (KR)

Correspondence Address: Robert E. Bushnell, Suite 300, 1522 K Street, N.W., Washington, DC, 20005, US

(21) Appl. No.: 11/592,273

(22) Filed: Nov. 3, 2006

(30) Foreign Application Priority Data
Dec. 12, 2005 (KR) 10-2005-0122162

(51) Int. Cl. H04J 14/00

(52) U.S. Cl. 398/69

(57) ABSTRACT

In a gigabit-capable passive optical network (GPON) and a method for bandwidth allocation in the GPON system, when an optical network unit (ONU) requests a bandwidth less than its preset minimum bandwidth, the requested bandwidth is allocated to the ONU. When there are traffic-container (T-CONT) classes of ONUs not allocated bandwidth after the requested bandwidth allocation, a spare bandwidth after the requested bandwidth allocation is dynamically allocated to the T-CONT class of each ONU according to a weight of each T-CONT class and a percentage of each T-CONT buffer queue. Thus, in the short term, upstream channel transmission according to T-CONT priority in a congested state can be ensured, and, in the long run, network traffic congestion can be prevented.

### CLAIM OF PRIORITY

This application makes reference to, incorporates the same herein, and claims all benefits accruing under 35 U.S.C. § 119 from an application for GPON SYSTEM AND METHOD FOR BANDWIDTH ALLOCATION IN GPON SYSTEM earlier filed in the Korean Intellectual Property Office on the 12 of Dec. 2005 and there duly assigned Serial No. 10-2005-0122162.

### BACKGROUND OF THE INVENTION

1. Technical Field

The present invention relates to a passive optical network (PON) system, and more particularly, to a method for bandwidth allocation for upstream in a gigabit-capable passive optical network (GPON) system.

2. Related Art

Subscriber networks have been rapidly changing in recent years. With the development of Internet service and xDSL technology, and the propagation of cable television (CATV) and wireless communication, a great number of people have come to use subscriber networks. In addition, high speed, stability, and quality of service need to be guaranteed. Subscriber networks have characteristics of a short arrival distance or around 20 km and distributed user traffic. In particular, in South Korea, a geographically small country, the arrival distance of a subscriber network is as short as about 10 km. A subscriber network is an arrangement of relatively simple systems each including a telephone office node, a subscriber access point (AP) node, and a single link connecting the two nodes. Such a network is called a loop. A loop cannot be substituted by another loop and individually corresponds to an independent line. Accordingly, routing, traffic, and network management in a subscriber network are different from those in a typical infrastructure network. As a result, the subscriber network may refer to an independent network requiring different techniques than those applied in a typical network.

Copper cable used in most of the current subscriber networks has a transmission loss limit. Accordingly, subscriber accommodation area is limited. Such a copper cable has a limit with respect to transmission loss and high frequency transmission, and the transmission characteristic of the copper cable is insufficient to provide broad-band service. A recent subscriber network, such as VDSL, can provide communication at an upstream/downstream rate of 6.4 Mbps/52 Mbps, or bi-directional communication at 13 Mbps for a distance up to 1.5 km, which may be insufficient to meet growing demand for broad-band multimedia in the near future. In view of this situation, the subscriber network may be built by using Fiber To The Home (FTTH) to satisfy future demand for broad-band multimedia. The subscriber network using FTTH has the advantages of an excellent optical cable transmission characteristic, no electrical failure, and the ability to meet future demand for broad-band using various multiplexing techniques. This subscriber network may be very competitive in view of the recent price drop of transceivers, passive optical devices, and the like.

A passive optical network (PON) has a subscriber network structure with a distributed topology having a tree structure formed by connecting several optical network units (ONUs) with one optical cable termination (OLT) using a passive splitter. PON technology can be used to build a highly reliable, inexpensive access network by shortening the total length of an optical cable and using only passive optical devices, and can deliver signals among several subscribers to a high-speed infrastructure network by combining and multiplexing the signals. Thus, a PON system has been suggested as suitable for implementing Fiber To The Home (FTTH) and Fiber To The Curb (FTTC).

PON includes four elements such as OLT, an optical distribution network (ODN), ONU, and an element management system (EMS). OLT functions as an interface between PON and a backbone network, such as an edge switch. EMS operates, manages, and maintains the entire PON system, and monitors the performance of the PON system. OLT may generally include an EMS function. ODN is composed of only passive optical elements, such as optical fiber, a splitter, and a connector, and has a bus or tree structure and a physical range of 20 km. ONU is a section which is directly connected with a subscriber network, and the position of ONU varies with its application, such as Fiber To The Building (FTTB), FTTC, Fiber To The Office (FTTO), and FTTH.

Examples of PONs include ATM PON (APON), Gigabit-capable PON (GPON), Ethernet PON (EPON), and Wavelength Division Multiplexing PON (WDMPON). Among them, EPON is attracting increasing attention as an attractive solution in a broad-band, high-speed subscriber network because it realizes low Ethernet equipment cost and low optics-based cost by using a popular Ethernet technique. In EPON, it is very important to control upstream traffic because different ONUs need to share an upstream channel in order to send data. In addition, with ongoing study of EPON, bandwidth use efficiency and quality of service (QoS) have been of growing concern.

GPON began at FSAN OAN WG in April 2001 with efforts to establish a standard capable of accommodating an Ethernet frame in conventional ATM-PON, as 95% of Internet traffic is delivered through the Ethernet frame and Ethernet data capacity rapidly increases from the 10 or 100M class to a Gpbs class. GPON has been achieved by major businesses such as NTT, SBC, BT and KT, and is currently standardized. For example, G984.X series recommendations were completed in June 2004. A fundamental rule of GPON is to accommodate ATM, Ethernet, and TDM services, and to maximally accommodate a basic design concept of a previous ATM-PON. GPON is aimed at a full service network (FSN), and has the characteristic of providing voice, HDTV class video, E1/T1 TDM service, and 10/100/1000 base Ethernet service in an upstream/downstream 622 Mbps/2.4 Gbps band.

In GPON, traffic on a downstream channel is broadcast from one OLT to a number of ONUs, while traffic on an upstream channel is transmitted from a number of ONUs to an upper OLT. Accordingly, a proper channel or time slot needs to be allocated to the upstream channel. Basically, GPON employs a dynamic bandwidth allocation (DBA) algorithm suggested by ATM-PON. However, GPON does not assure quality of various services and performance defined by Traffic-Container (T-CONT).

A standard for the GPON system was no longer announced after the ITU-T recommendation G.984.4 was announced in June 2004. Because DBA in the GPON system is not yet actively studied, a DBA algorithm in GPON accommodates a conventional ATM-PON BPON system.

In a suggested bandwidth allocation system in ATM-PON, each ONU has several QoS sub-queues, monitors a queue length of a buffer which accommodates cells generated from a non-real-time connection, and delivers the queue length to an OLT through a mini-slot. The OLT calculates a bandwidth allocated to each ONU by referring to bandwidth information defined in each ONU and the number of non-real-time cells delivered through the mini-slot, and allocates to the ONU a data grant corresponding to the calculated bandwidth. In response to receiving the grant, the ONU selects one QoS sub-queue through a weighted round robin (WRR) scheduler and transmits one cell in the sub-queue to OLT on the slot.

The method for dynamic bandwidth allocation in ATM-PON supports quality of various services by using five requested items of bandwidth information defined in each ONU, as well as buffer state information of the ONU obtained through the mini-slot. The five requested items of bandwidth information are a fixed bandwidth, an assured bandwidth, an effective bandwidth, a maximum bandwidth, and a dynamic bandwidth.

Among the five requested items of bandwidth information, the fixed bandwidth is periodically allocated to the ONU at all times, and is defined as the sum of peak cell rates (PCRs) of all real-time connections which are established in the ONU. The assured bandwidth is an average bandwidth which is assured for non-real-time connections of the ONU, and is defined as the sum of sustainable cell rates (SCR) or minimum cell rates (MCRs) for the established non-real-time connections. This value is updated only when a new non-real-time connection is established or released, and is referred to when a dynamic bandwidth to be allocated to non-real-time traffic is calculated.

Furthermore, the maximum bandwidth is a maximum bandwidth which can be allocated to the ONU, and is defined as the sum of peak cell rates of all connections established in the ONU. The effective bandwidth is an average bandwidth which should be ensured for real-time connections of the ONU, and is defined as the sum of SCRs of the established real-time connections. In the case of constant bit rate (CBR) service, the SCR may be equal to the PCR.

Finally, the dynamic bandwidth is defined as a bandwidth allocated to the ONU according to a DBA algorithm in a bandwidth remaining after the fixed bandwidth is allocated based on the number of non-real-time cells in a standby state in the ONU and the assured bandwidth information set in each ONU.

In the conventional algorithm, since the fixed bandwidth and the assured bandwidth are first distributed to each ONU, if a specific ONU is allotted less fixed, assured, and dynamic bandwidths relative to the other ONUs, the specific ONU may be not allocated the dynamic bandwidth even though it uses relatively less bandwidth than the other ONUs.

### SUMMARY OF THE INVENTION

It is an object of the present invention to provide a gigabit-capable passive optical network (GPON) system, and a method for bandwidth allocation in the GPON system, which are capable of more efficiently and fairly allocating a bandwidth by considering fairness between optical network units (ONUs) and the length of a queue of each traffic-container (T-CONT).

One aspect of the present invention provides a method for bandwidth allocation in a passive optical network (PON) system, in which an optical cable termination (OLT) allocates an upstream bandwidth to at least one ONU, the method comprising the steps of: when an ONU requests a bandwidth less than its preset minimum bandwidth, allocating the requested bandwidth to the ONU; and, when there are T-CONT classes of ONUs not allocated bandwidth after the requested bandwidth allocation, dynamically allocating a spare bandwidth after the requested bandwidth allocation to the T-CONT class of each ONU according to the weight of each T-CONT class and the percentage of each T-CONT buffer queue.

The step of dynamically allocating the spare bandwidth may comprise the steps of: calculating a weight of each ONU and an allocation bandwidth for the T-CONT class of each ONU according to the weight of each T-CONT class and the percentage of each T-CONT buffer queue; assigning a priority to each ONU according to the calculated weight of each ONU; and allocating the calculated bandwidth to each ONU preferentially in order of the assigned priority.

The weight of the T-CONT class of each ONU may be represented by the following equation:
P(i,j)=α×kⱼ+(1−α)×A(j),
where kⱼ denotes the weight of each T-CONT class, A(j) denotes a proportion of a total buffer size of T-CONT class j occupied by a traffic queue waiting for transmission, and a denotes a parameter value set by a system manager or a network manager.

A priority of each ONU may be calculated by the following equation:
Highest Priority=arg max {Pᵢ}
where Pᵢ denotes a weight of the i-th ONU.

The α parameter may increase to assure high-priority traffic transmission and decrease to eliminate a bottleneck phenomenon in the T-CONT buffer.

The weight of each T-CONT class may be set according to importance, which is dependent on the traffic characteristic of each T-CONT class, and the sum of the weights of the T-CONT classes is one.

The method may further comprise the step of calculating an allocation bandwidth for each ONU from the bandwidth dynamically assigned to the T-CONT class of each ONU, and transmitting the calculated information to each ONU.

The bandwidth dynamically assigned to each ONU may be calculated by the following equation:

$${Additional\_BW}_{ij} = \frac{P ( i , j )}{{\sum }_{i = 1}^{N} {\sum }_{j = 1}^{5} P ( i , j )} \times remaining BW ,$$

where Additional_BWᵢⱼ denotes a dynamic bandwidth allocated to T-CONT class j of the i-th ONU, P(i,j) denotes a weight of the T-CONT class j of the i-th ONU, and remaining BW denotes a spare bandwidth remaining after the requested bandwidth allocation to some ONUs.

Another aspect of the present invention provides a PON system comprising: an OLT which, when an ONU requests a bandwidth less than its preset minimum bandwidth, allocates the requested bandwidth to the ONU and, when there are T-CONT classes of ONUs not allocated bandwidth after the requested bandwidth allocation, dynamically allocates a spare bandwidth after the requested bandwidth allocation to the T-CONT class of each ONU according to a weight of each T-CONT class and a percentage of each T-CONT buffer queue; and at least one ONU for transmitting upstream traffic to the OLT through the bandwidth assigned by the OLT.

Yet another aspect of the present invention provides an OLT for allocating an upstream bandwidth to at least one ONU, wherein: when an ONU requests a bandwidth less than its preset minimum bandwidth, the OLT allocates the requested bandwidth to the ONU; and when there are T-CONT classes of ONUs not allocated bandwidth after the requested bandwidth allocation, the OLT dynamically allocates a spare bandwidth after the requested bandwidth allocation to the T-CONT class of each ONU according to a weight of each T-CONT class and a percentage of each T-CONT buffer queue.

### BRIEF DESCRIPTION OF THE DRAWINGS

A more complete appreciation of the invention, and many of the attendant advantages thereof, will be readily apparent as the same becomes better understood by reference to the following detailed description when considered in conjunction with the accompanying drawings, in which like reference symbols indicate the same or similar components, wherein:

FIG. 1 is a flowchart of a dynamic bandwidth allocation procedure in a passive optical network (PON) system;

FIG. 2 is a diagram of the structure of a PON system according to the present invention;

FIG. 3 is a diagram of the configuration of a queue of each traffic-container (T-CONT) class of an optical network unit (ONU) according to the present invention; and

FIG. 4 is a flowchart of a method for bandwidth allocation in a gigabit-capable passive optical network (GPON) system according to an exemplary embodiment of the present invention.

### DETAILED DESCRIPTION OF THE INVENTION

Hereinafter, exemplary embodiments of the present invention will be described in detail with reference to the accompanying drawings. In the following description, a detailed description of known functions and configurations incorporated herein has been omitted for conciseness.

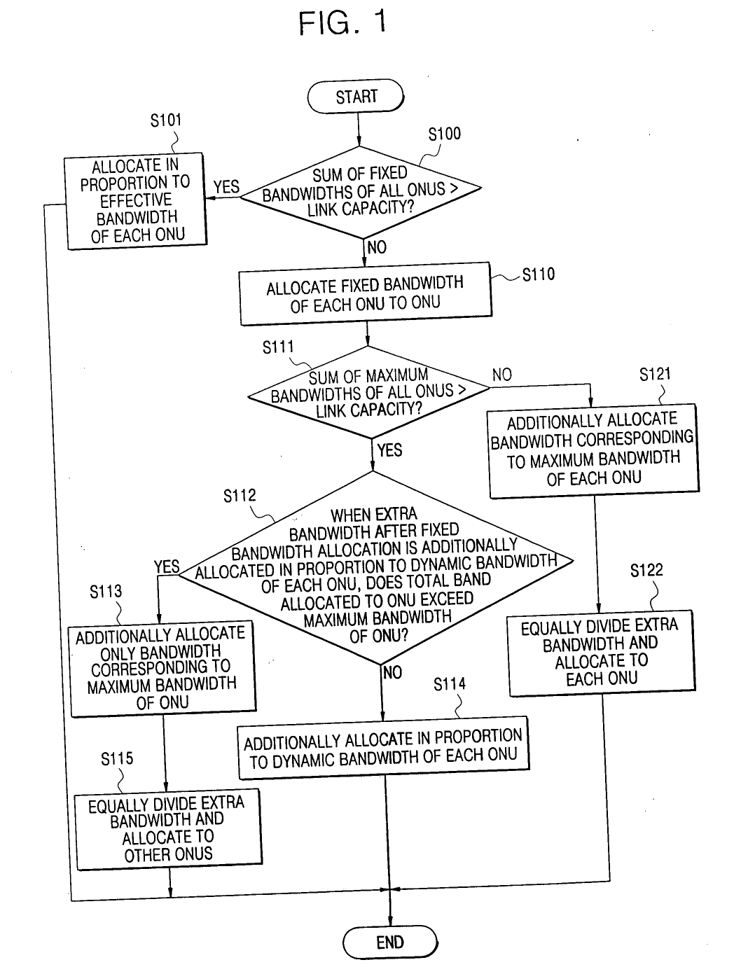

FIG. 1 is a flowchart of a dynamic bandwidth allocation procedure in a passive optical network (PON) system.

A basic dynamic bandwidth allocation (DBA) procedure using the above five requested items of bandwidth information will be described with reference to FIG. 1.

First, it is determined whether the sum of fixed bandwidths of all optical network units (ONUs) exceeds available link capacity (S100). If the sum of fixed bandwidths of all ONUs exceeds the available link capacity (YES in S100), bandwidth is allocated to each ONU in proportion to the effective bandwidth of the ONU (S101). In this case, the bandwidth allocated in proportion to the effective bandwidth becomes the fixed bandwidth of the ONU.

If the sum of the fixed bandwidths of all ONUs does not exceed the available link capacity (NO in S100), the fixed bandwidth of each ONU is allocated to the ONU (S110). For a spare bandwidth remaining after the fixed bandwidth allocation to each ONU, it is determined whether the sum of the maximum bandwidths of all ONUs exceeds the link capacity (S111). If the sum of the maximum bandwidths of all ONUs does not exceed the link capacity (NO in S111), a bandwidth corresponding to the maximum bandwidth of each ONU is additionally allocated (S121). Spare bandwidth remaining after additional allocation of the bandwidth corresponding to the maximum bandwidth of each ONU is equally divided and allocated to each ONU (S122).

On the other hand, if the sum of the maximum bandwidths of all ONUs exceeds the link capacity (YES in S111) and the spare bandwidth after the fixed bandwidth allocation is additionally allocated in proportion to the dynamic bandwidth of each ONU, it is determined whether a total bandwidth to be allocated to the ONU (the fixed bandwidth plus the dynamic bandwidth) exceeds the maximum bandwidth of the ONU (S112). If the total bandwidth to be allocated to the ONU exceeds the maximum bandwidth of the ONU, only a bandwidth corresponding to the maximum bandwidth of the ONU is additionally allocated (S113). The remaining spare bandwidth is equally divided and allocated to other ONUs (S115). If the total bandwidth allocated to the ONU does not exceed the maximum bandwidth of the ONU (NO in S112), the bandwidth is additionally allocated in proportion to the dynamic bandwidth of each ONU (S114).

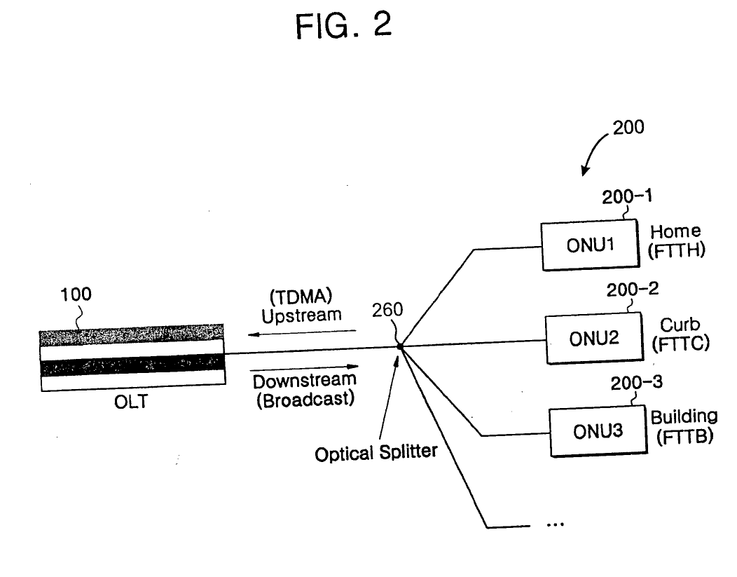

FIG. 2 is a diagram of the structure of a PON system according to the present invention.

The Ethernet passive optical network (EPON) system includes an optical cable termination (OLT) 100, optical network units (ONUs) 200, an optical splitter 260, and the like, as shown in FIG. 2. As previously described, downstream traffic from the OLT 100 to the ONUs 200 is transmitted using a broadcast system, and upstream traffic from the ONUs 200 to the OLT 100 is transmitted using a TDMA system.

As shown in FIG. 2, in the PON system, downstream transmission flow from an external network to a subscriber is achieved from the OLT 100 to all ONUs 200-1, 200-2 and 200-3 in a point-to-multi-point manner due to a physical tree connection characteristic of the PON system. On the other hand, since upstream transmission flow from the subscriber to the external network is achieved in a point-to-point manner between each ONU 200-1, 200-2 and 200-3 and the OLT 100, the respective distributed ONUs 200-1, 200-2 and 200-3 need to transmit data to the OLT 100 without conflicting with each other. The GPON uses a time division multiple access (TDMA) system as a bandwidth allocation system for upstream bandwidth access from a number of ONUs to one OLT.

In FIG. 2, the OLT 100 requests a report for traffic-containers (T-CONTs) of each ONU 200 using physical control block downstream (PCBD) of downstream traffic at specific periods. Upon receipt of the request, each ONU 200 reports a queue state of each T-CONT. In response to receiving the report on the current queue state of T-CONTs of each ONU 200, the OLT 100 allocates a bandwidth to each T-CONT.

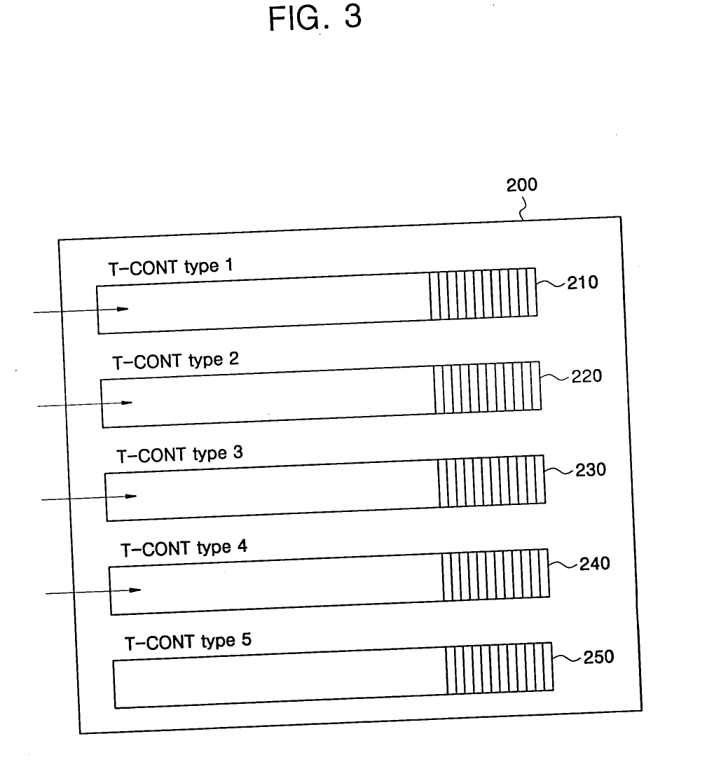

FIG. 3 is a diagram of the configuration of a queue of each traffic container (T-CONT) class of an optical network unit (ONU) according to the present invention.

Referring to FIG. 3, an ONU 200 according to the present invention has queues 210, 220, 230, 240 and 250 of a traffic container (T-CONT) type, such as T-CONT1, T-CONT2, T-CONT3, T-CONT4 and T-CONT5 according to the ITU-T G.983.4 specification. T-CONT1 is defined for a fixed bandwidth, T-CONT2 for an assured bandwidth, T-CONT3 for assured and non-assured bandwidths, and T-CONT4 for a best effort (BE) bandwidth. T-CONT5 is provided for operations administration and maintenance (OAM) and queue-length report.

The priority according to the bandwidth is high in order of fixed bandwidth, assured bandwidth, non-assured bandwidth, and BE bandwidth. As the priority of each T-CONT is determined in such a manner, the priority is set in order of T-CONT1, T-CONT2, T-CONT3, and T-CONT4.

The ONU 200 transmits upstream traffic of each T-CONT class using the bandwidth allocated by the OLT 100.

In this manner, the method for bandwidth allocation based on the PON structure shown in FIGS. 2 and 3 according to the present invention includes the process of allocating a bandwidth to obtain fairness between the ONUs 200, and the process of elastically allocating a spare bandwidth which can effectively accommodate burst traffic.

To obtain the fairness between ONUs 200, the OLT 100 allocates a minimum bandwidth Min_BW to each ONU in the tree structure. The minimum bandwidth ensures minimal transmission for each ONU. Thereafter, the OLT 100 allocates a requested bandwidth to an ONU when the sum of bandwidths of T-CONTs requested by the ONU does not exceed a bandwidth allocated to the ONU, and dynamically allocates the bandwidth to the ONU according to a weight of each T-CONT class and a percentage of each T-CONT buffer queue when the sum of the requested bandwidths exceeds the specified minimum allocation bandwidth. The minimum bandwidths may differ between ONUs and may be preset by a system manager.

A portion of the allocated bandwidth is allocated to each T-CONT according to an ONU scheduling method. The minimum bandwidth is a parameter specified by the network manager, and enables the network manager to elastically build the network. After such a process is performed on each ONU, a spare bandwidth and T-CONTs not allocated bandwidth may result if the sum of the minimum allocation bandwidths allocated to the respective ONUs is smaller than the whole link capacity.

After the requested bandwidth is allocated to each ONU, the spare bandwidth is dynamically allocated according to a weight of each T-CONT class and a rate of the T-CONT buffer queue. That is, the bandwidth allocation method according to the present invention can prevent long-term congestion in the network by considering the length of the queue of the T-CONT of the ONU.

The bandwidth dynamically allocated to each class of each ONU according to the present invention is calculated by the following Equation 1:

$${Additional\_BW}_{ij} = \frac{P ( i , j )}{{\sum }_{i = 1}^{N} {\sum }_{j = 1}^{5} P ( i , j )} \times remaining BW , \qquad Equation 1$$

where Additional_BWᵢⱼ denotes a dynamic bandwidth allocated to T-CONT class j of the i-th ONU, P(i,j) denotes a weight of the T-CONT class j of the i-th ONU, and remaining BW denotes spare bandwidth remaining after the requested bandwidth allocation to some ONUs.

The weight of each T-CONT class of each ONU may be represented by the following Equation 2:
P(i,j)=α×kⱼ+(1−α)×A(j) Equation 2
where kⱼ denotes a weight of each T-CONT class, A(j) denotes a proportion of the total buffer size of the T-CONT class j occupied by a traffic queue waiting for transmission, and a denotes a parameter value set by a system manager or a network manager, which may be adjusted according to network policy. In this regard, kⱼ is a value set according to the importance of each class, and the sum of all k values is one. That is, the sum of weights of all the T-CONT classes equals one.

In Equation 2, the first term α×kⱼ denotes an index assuring high-priority traffic transmission in a network overload state. It serves to assure priority-based transmission through α value adjustment by the network manager when there is heavy traffic.

The second term (1−α)×A(j) serves to reduce network congestion. Specifically, the second term serves to prevent long-term network congestion by efficiently eliminating a bottleneck phenomenon which may affect the T-CONT of a specific ONU through preferential service for T-CONTs of ONUs having a long queue. Therefore, a policy of increasing a to assure high-priority traffic transmission and decreasing α to prevent network congestion by eliminating a bottleneck phenomenon in a T-CONT buffer of the ONU can provide effective network management.

In the present invention, the order in which bandwidth is allocated to the ONUs is defined. A priority for bandwidth allocation is given by the following Equation 3:
Highest Priority=arg max {Pᵢ}, Equation 3
where Pᵢ denotes a weight of the i-th ONU. Pᵢ can be calculated by the following Equation 4:

$${P}_{i} = {\sum }_{j = 1}^{5} P ( i , j ) , \qquad Equation 4$$

where P(i,j) denotes the weight of the T-CONT class j of the i-th ONU, as previously described. Accordingly, the highest priority indicating a weight of the highest priority ONU becomes a weight of the ONU having the largest P value. According to the present invention, the bandwidth is dynamically allocated to each ONU every report period based on the calculated P value. In this case, the ONU having the highest priority is allocated bandwidth first, the ONU having the second highest priority is allocated bandwidth second, and so on, in order of priority.

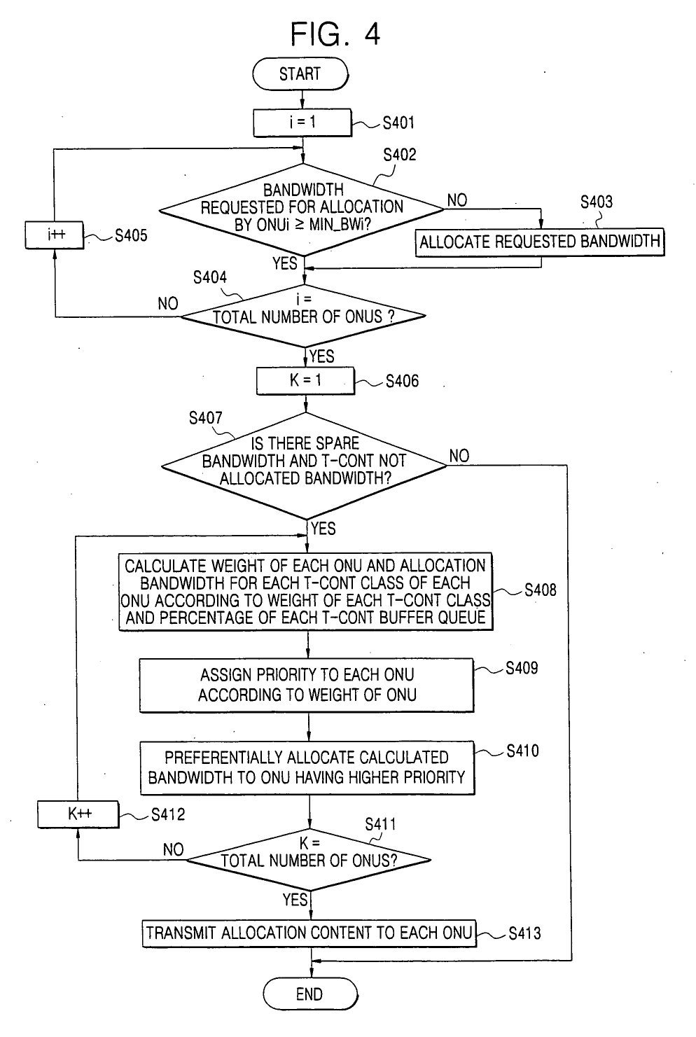

The above-described method for bandwidth allocation according to the present invention may be summarized as shown in FIG. 4.

FIG. 4 is a flowchart of a method for bandwidth allocation in a gigabit-capable passive optical network (GPON) system according to an exemplary embodiment of the present invention.

An index i indicating a particular ONU is set and initialized as 1 (S401). The OLT 100 receives a request for bandwidth allocation from an ONUi, and determines whether the requested bandwidth exceeds a minimum bandwidth Min_BWi of the ONUi (S402). If the requested bandwidth does not exceed the minimum bandwidth (NO in S402), the OLT 100 allocates the bandwidth requested by the ONUi (S403).

Since steps S402 and S403 should be performed on all ONUs, they need to be repeated until the index i reaches the total number of ONUs in the system. To this end, it is determined whether i is equal to the total number of ONUs in the system (S404). If i is not equal to the total number of ONUs (NO in S404), i is incremented by one (S405) and steps S402 and S403 are repeated.

If i is equal to the total number of ONUs in the system (YES in S404), the minimum bandwidth allocation procedure ends and the dynamic bandwidth allocation process begins.

The dynamic bandwidth allocation process begins with setting the value of the index k, indicating the T-CONT class, to 1 (S407). After allocating the minimum bandwidth, the OLT 100 requests the ONU to report whether there are any T-CONTs not allocated bandwidth. Upon receipt of the report from the ONU, the OLT 100 determines whether there are spare bandwidth and T-CONTs not allocated bandwidth after the minimum bandwidth allocation (S407). If a positive determination is made (YES in S407), the OLT 100 enters a process for dynamic bandwidth allocation according to a weight of each T-CONT class and the rate of a T-CONT buffer queue.

First, the weight of each ONU and an allocation bandwidth for each T-CONT class of each ONU are calculated according to the weight of each T-CONT class and the percentage of each T-CONT buffer queue (S408). Equation 2 is used to calculate an allocation bandwidth for each T-CONT class of each ONU, and Equation 3 is used to calculate the weight of each ONU. After the weight of each ONU is calculated, a priority of each ONU is given according to the calculated weight of each ONU (S409). The calculated bandwidth is preferentially allocated to the ONU having the higher given priority (S410). In this case, the bandwidth allocated to each ONU may be calculated from the sum of bandwidths dynamically assigned to the T-CONT classes of each ONU, using Equation 1.

Since steps S408 to S410 should be repeated for every ONU, it is determined whether the index k, indicating each ONU, is equal to the total number of ONUs (S411). If not (NO in S411), k is incremented by l (S412), and steps S408 to S410 are repeated.

When the index k is equal to the total number of ONUs (YES in S411), the dynamic allocation to all ONUs is completed, and assigned or allocation content is transmitted to each ONU (S413).

According to the present invention, it is possible to ensure, in the short term, upstream channel transmission according to T-CONT priority in a congested state, and to prevent, in the long run, network traffic congestion. This is accomplished by dynamically allocating bandwidth in the G-PON system in simultaneous consideration of minimal fairness among ONUs as well as T-CONT priority and queue.

While the present invention has been described with reference to exemplary embodiments thereof, it will be understood by those skilled in the art that various changes in form and detail may be made therein without departing from the scope of the present invention as defined by the following claims.

What is claimed is:

1. A method for bandwidth allocation in a passive optical network (PON) system, in which an optical cable termination (OLT) allocates an upstream bandwidth to at least one optical network unit (ONU), the method comprising the steps of:
when an ONU requests a bandwidth less than its preset minimum bandwidth, allocating the requested bandwidth to the ONU; and
when there are traffic-container (T-CONT) classes of ONUs not allocated bandwidth after the requested bandwidth allocation, dynamically allocating a spare bandwidth after the requested bandwidth allocation to the T-CONT class of each ONU according to a weight of each T-CONT class and a percentage of each T-CONT buffer queue.

2. The method of claim 1, wherein the step of dynamically allocating the spare bandwidth comprises the steps of:
calculating a weight of said each ONU and an allocation bandwidth for the T-CONT class of said each ONU according to the weight of said each T-CONT class and the percentage of said each T-CONT buffer queue;
assigning a priority to said each ONU according to the calculated weight of said each ONU; and
allocating the calculated bandwidth to said each ONU preferentially in order of the assigned priority.

3. The method of claim 1, wherein the weight of the T-CONT class of said each ONU is represented by the following equation:
P(i, j)=α×kj+(1−α)×A(j)
where kⱼ denotes the weight of said each T-CONT class j, A(j) denotes a proportion of a total buffer size of said each T-CONT class j occupied by a traffic queue waiting for transmission, and α denotes a parameter value set by one of a system manager and a network manager.

4. The method of claim 3, wherein the priority of said each ONU is calculated by the following equation:
Highest Priority=arg max {Pᵢ},
where Pᵢ denotes a weight of the i-th ONU.

5. The method of claim 3, wherein α increases to assure high-priority traffic transmission and decreases to eliminate a bottleneck phenomenon in the T-CONT buffer.

6. The method of claim 1, wherein the weight of said each T-CONT class is set according to importance, which is dependent on a traffic characteristic of said each T-CONT class, and wherein the sum of the weights of the T-CONT classes is one.

7. The method of claim 1, further comprising the steps of calculating an allocation bandwidth for said each ONU from the bandwidth dynamically assigned to the T-CONT class of said each ONU, and transmitting the calculated information to said each ONU.

8. The method of claim 7, wherein the bandwidth dynamically assigned to said each ONU is calculated by the following equation:
$${Additional\_BW}_{ij} = \frac{P ( i , j )}{{\sum }_{i = 1}^{N} {\sum }_{j = 1}^{5} P ( i , j )} \times remaining BW ,$$
where Additional_BWᵢⱼ denotes a dynamic bandwidth allocated to T-CONT class j of the i-th ONU, P(i,j) denotes a weight of the T-CONT class j of the i-th ONU, and remaining BW denotes a spare bandwidth remaining after the requested bandwidth allocation to some ONUs.

9. A passive optical network (PON) system, comprising:
an optical cable termination (OLT) which, when an optical network unit (ONU) requests a bandwidth less than its preset minimum bandwidth, allocates the requested bandwidth to the ONU and, when there are traffic-container (T-CONT) classes of ONUs not allocated bandwidth after the requested bandwidth allocation, the OLT dynamically allocates a spare bandwidth after the requested bandwidth allocation to the T-CONT class of each ONU according to a weight of each T-CONT class and a percentage of each T-CONT buffer queue; and
at least one ONU for transmitting upstream traffic to the OLT through the bandwidth assigned by the OLT.

10. The PON system of claim 9, wherein the OLT calculates a weight of said each ONU and an allocation bandwidth for the T-CONT class of said each ONU according to the weight of said each T-CONT class and the percentage of said each T-CONT buffer queue, assigns a priority to said each ONU according to the calculated weight of said each ONU, and allocates the calculated bandwidth to said each ONU preferentially in order of the assigned priority.

11. The PON system of claim 9, wherein the weight of the T-CONT class of said each ONU is represented by the following equation:
P(i, j)=α×kⱼ+(1−α)×A(j)
where kⱼ denotes the weight of said each T-CONT class j, A(j) denotes a proportion of a total buffer size of said each T-CONT class j occupied by a traffic queue waiting for transmission, and α denotes a parameter value set by one of a system manager and a network manager.

12. The PON system of claim 11, wherein the priority of said each ONU is calculated by the following equation:
Highest Priority=arg max {Pᵢ},
where Pᵢ denotes a weight of the i-th ONU.

13. The PON system of claim 11, wherein α increases to assure high-priority traffic transmission and decreases to eliminate a bottleneck phenomenon in the T-CONT buffer.

14. The PON system of claim 9, wherein the weight of said each T-CONT class is set according to importance, which is dependent on a traffic characteristic of said each T-CONT class, and wherein the sum of the weights of the T-CONT classes is one.

15. The PON system of claim 9, wherein the OLT calculates an allocation bandwidth for said each ONU from the bandwidth dynamically assigned to the T-CONT class of said each ONU, and transmits the calculated information to said each ONU.

16. The PON system of claim 15, wherein the bandwidth dynamically assigned to said each ONU is calculated by the following equation:
$${Additional\_BW}_{ij} = \frac{P ( i , j )}{{\sum }_{i = 1}^{N} {\sum }_{j = 1}^{5} P ( i , j )} \times remaining BW ,$$
where Additional_BWᵢⱼ denotes a dynamic bandwidth allocated to a T-CONT class j of the i-th ONU, P(i,j) denotes a weight of the T-CONT class j of the i-th ONU, and remaining BW denotes a spare bandwidth remaining after the requested bandwidth allocation to some ONUs.

17. An optical cable termination (OLT) for allocating an upstream bandwidth to at least one optical network unit (ONU), wherein:
when an ONU requests a bandwidth less than its preset minimum bandwidth, the OLT allocates the requested bandwidth to the ONU; and
when there are traffic-container (T-CONT) classes of ONUs not allocated bandwidth after the requested bandwidth allocation, the OLT dynamically allocates a spare bandwidth after the requested bandwidth allocation to the T-CONT class of each ONU according to a weight of each T-CONT class and a percentage of each T-CONT buffer queue.

18. The OLT of claim 17, wherein the weight of the T-CONT class of said each ONU is represented by the following equation:
P(i, j)=α×kj+(1−α)×A(j)
where kⱼ denotes the weight of each T-CONT class j, A(j) denotes a proportion of a total buffer size of said each T-CONT class j occupied by a traffic queue waiting for transmission, and a denotes a parameter value set by one of a system manager and a network manager.

19. The OLT of claim 18, wherein the OLT calculates a weight of said each ONU and an allocation bandwidth for the T-CONT class of said each ONU according to the weight of said each T-CONT class and the percentage of said each T-CONT buffer queue, assigns a priority to said each ONU according to the calculated weight of said each ONU, and allocates the calculated bandwidth to said each ONU preferentially in order of the assigned priority.
